(19) United States
(12) Patent Application Publication
(10) Pub. No.: US 2019/0073147 A1
(43) Pub. Date: Mar. 7, 2019

(54) CONTROL DEVICE, METHOD AND NON-TRANSITORY COMPUTER-READABLE STORAGE MEDIUM

(71) Applicant: FUJITSU LIMITED, Kawasaki-si (JP)

(72) Inventors: Yuichi Ogawa, Kawasaki (JP); Tomoyuki Kanayama, Kawasaki (JP); Yuzo KORI, Kawasaki (JP); Tomoharu Muro, Kawasaki (JP)

(73) Assignee: FUJITSU LIMITED, Kawasaki-shi (JP)

(21) Appl. No.: 16/117,213

(22) Filed: Aug. 30, 2018

(30) Foreign Application Priority Data
Sep. 5, 2017 (JP) 2017-170088

(51) Int. Cl. G06F 3/06; G06F 12/0842

(52) U.S. Cl. CPC G06F 3/0625; G06F 12/0842; G06F 2212/608; G06F 3/068; G06F 2212/1028; G06F 3/0659

(57) ABSTRACT

A control device includes a nonvolatile memory, a first processor, a first volatile memory coupled to the first processor, a second processor, and a second volatile memory coupled to the second processor, wherein the first processor is configured to transmit first data stored in the first volatile memory to the second processor by using electric power supplied from a backup power supply, the second processor is configured to store the first data in the second volatile memory, after storing the first data in the second volatile memory, the backup power supply stops supplying the electric power to at least one of the first volatile memory and the first processor, and the second processor is configured to store, in the nonvolatile memory, the first data stored in the second volatile memory.

### CROSS-REFERENCE TO RELATED APPLICATION

This application is based upon and claims the benefit of priority of the prior Japanese Patent Application No. 2017-170088, filed on Sep. 5, 2017, the entire contents of which are incorporated herein by reference.

### FIELD

The embodiment discussed herein is related to a control device, a method and a non-transitory computer-readable storage medium.

### BACKGROUND

A storage system includes a controller and a plurality of storage devices and records and manages a large amount of data treated in information processing. The controller includes a central processing unit (CPU) and a cache memory that exchanges data with the CPU. As the storage devices, for example, a hard disk drive (HDD) or a solid state drive (SSD) higher in speed than the HDD is used.

On the other hand, during normal operation of a system, when power supply to the system stops because of a power failure or the like, cache data stored in a volatile cache memory is lost. Therefore, a backup power supply unit and a nonvolatile backup disk are mounted on the system.

When the power supply to the system stops, while the cache data stored in the cache memory is saved in the backup disk, power feeding from the backup power supply unit is performed. Consequently, the cache data is preserved. As related art, there are Japanese Laid-open Patent Publication Nos. 2008-225916, 2006-172355, and 9-160838.

### SUMMARY

According to an aspect of the invention, a control device includes a nonvolatile memory, a first processor, a first volatile memory coupled to the first processor, a second processor, and a second volatile memory coupled to the second processor, wherein the first processor is configured to transmit first data stored in the first volatile memory to the second processor by using electric power supplied from a backup power supply, the second processor is configured to store the first data in the second volatile memory, after storing the first data in the second volatile memory, the backup power supply stops supplying the electric power to at least one of the first volatile memory and the first processor, and the second processor is configured to store, in the nonvolatile memory, the first data stored in the second volatile memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the configuration of a control device.

FIG. 2 is a diagram illustrating an example of backup processing.

FIG. 3 is a diagram illustrating an example of the configuration of a storage system.

FIG. 4 is a diagram illustrating an example of data content stored in cache memories.

FIG. 5 is a diagram illustrating an example of a hardware configuration of a storage control device.

FIG. 6 is a diagram illustrating an example of the backup processing.

FIG. 7 is a diagram illustrating an example of a data storage image of the cache memories during the backup processing.

FIG. 8 is a sequence chart illustrating the operation of the backup processing of the storage control device.

FIG. 9 is a sequence chart illustrating the operation of the backup processing of the storage control device.

FIG. 10 is a flowchart illustrating an example of operation for securing a copy region.

FIG. 11 is a flowchart illustrating an example of operation for determining possibility for the backup processing according to a power supply capacity of a backup power supply unit.

FIG. 12 is a diagram illustrating an example of the configuration of a storage system.

FIG. 13 is a diagram illustrating an example of the configuration of a storage control device.

FIG. 14 is a diagram illustrating an example of the backup processing.

FIG. 15 is a diagram illustrating an example of the configuration of a storage control device including four processors.

FIG. 16 is a diagram illustrating an example of the backup processing.

### DESCRIPTION OF EMBODIMENT

According to an increase in capacities of storage devices in recent years, when a storage device is added, a memory capacity of a cache memory is also increased to achieve improvement of performance of a storage system.

However, when a saving time of cache data in a backup disk increases in proportion to the increase in the memory capacity of the cache memory, a power supply capacity of a backup power supply unit is increased according to the increased saving time. This causes an increase in cost and an increase in a device size.

An embodiment is explained below with reference to the drawings.

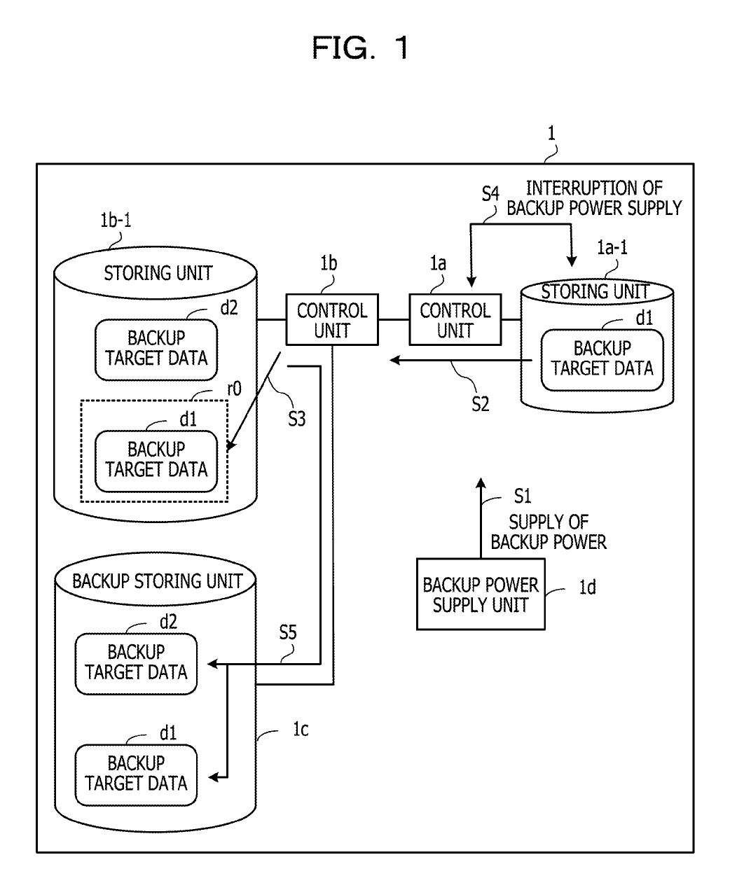

FIG. 1 is a diagram illustrating an example of the configuration of a control device. A control device 1 includes a control unit 1a (a first control unit), a storing unit 1a-1 (a first volatile storing unit) provided to be paired with the control unit 1a, a control unit 1b (a second control unit), and a storing unit 1b-1 (a second volatile storing unit) provided to be paired with the control unit 1b.

Further, the control device 1 includes a backup storing unit is (a nonvolatile storing unit) and a backup power supply unit 1d. The backup storing unit 1c is a nonvolatile storage medium that backs up data during a supply stop of a normal power supply due to a power failure or the like. During the supply stop of the normal power supply, the backup power supply unit 1d supplies backup power to constituent units for which backup processing is performed.

That is, during the supply stop of the normal power supply, the control units 1a, 1b, the storing units 1a-1, 1b-1, and the backup storing unit 1c are driven by the backup power supplied from the backup power supply unit 1d. Note that the backup storing unit is and the backup power supply unit 1d may be configured to be disposed on the outside of the control device 1.

The operation of the backup processing of the control device 1 is explained below with reference to the example illustrated in FIG. 1.

[Step S1] When supply of normal power to the control device 1 is stopped by a power failure or the like, backup power is supplied to the control units 1a, 1b, the storing units 1a-1, 1b-1, and the backup storing unit 1c from the backup power supply unit 1d.

[Step S2] The control unit 1a transmits backup target data d1 (first backup target data) stored in the storing unit 1a-1 to the control unit 1b.

[Step S3] The control unit 1b performs copy processing for copying the backup target data d1 to a non-backup target region r0 of the storing unit 1b-1. The non-backup target region r0 is a storage region in which the backup target data is not written.

[Step S4] After completion of the copy processing, the control unit 1a interrupts at least one of the backup power supply to the storing unit 1a-1 and the backup power supply to itself (the control unit 1a).

[Step S5] The control unit 1b transfers backup target data d2 (second backup target data) stored in the storing unit 1b-1 and the backup target data d1 copied to the non-backup target region r0 of the storing unit 1b-1 to the backup storing unit 1c and performs data saving processing.

In this way, during the backup processing, the control device 1 copies storage content of the storing unit 1a-1 on the control unit 1a side to the storing unit 1b-1 on the control unit 1b side. After completion of the copying, the control device 1 interrupts the backup power supply to at least one of the control unit 1a and the storing unit 1a-1 and performs data backup on the control unit 1b side.

Consequently, the control device 1 reduces a power supply amount of the backup power supply unit 1d. Therefore, it is possible to reduce an increase in a power supply capacity of the backup power supply unit 1d even during a memory capacity increase of the storing units 1a-1, 1b-1.

Before details of a technique of the present disclosure is explained, a state in which a power supply capacity of the backup power supply is added in proportion to an increase in a memory capacity of cache memories is explained.

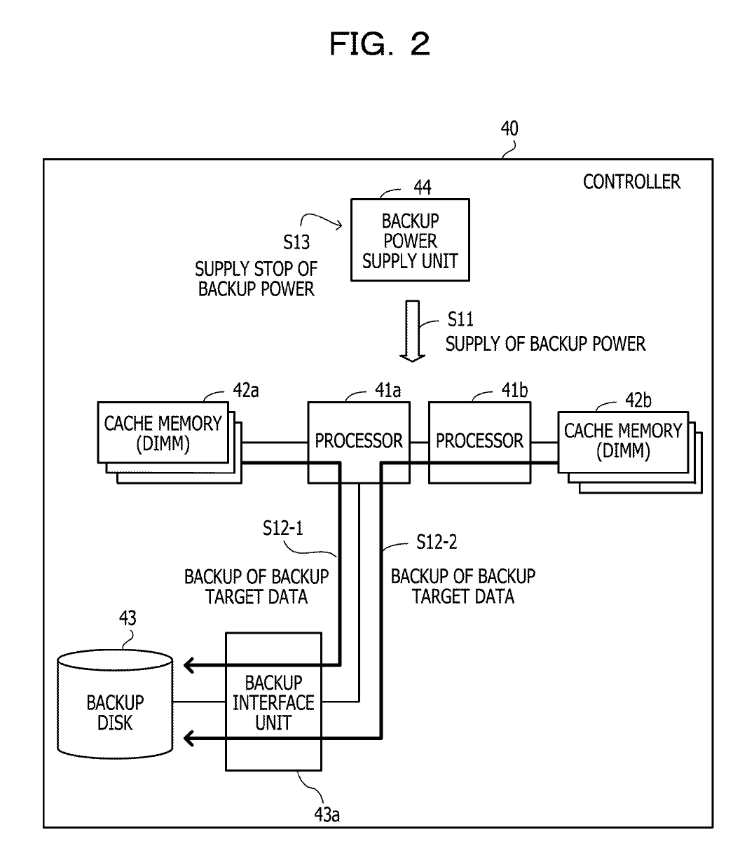

FIG. 2 is a diagram illustrating an example of the backup processing. A controller 40 includes a processor 41a, a cache memory 42a subordinate to the processor 41a, a processor 41b, and a cache memory 42b subordinate to the processor 41b. Further, the controller 40 includes a backup disk 43, a backup interface unit 43a, and a backup power supply unit 44.

The processors 41a, 41b perform overall control of the controller 40. The cache memories 42a, 42b store various data involved in program execution of the processors 41a, 41b.

As the cache memories 42a, 42b, for example, a dual inline memory module (DIMM) is used. The DIMM is a memory module in which a plurality of dynamic random access memories (DRAMs) are mounted on a substrate.

The backup disk 43 backs up data. The backup interface unit 43a is located between the backup disk 43 and the processor 41a and performs data transfer interface. The backup power supply unit 44 supplies backup power to predetermined constituent units in the controller 40.

[Step S11] During the supply stop of the normal power supply, the backup power supply unit 44 supplies the backup power to the processors 41a, 41b, the cache memories 42a, 42b, the backup interface unit 43a, and the backup disk 43.

[Step S12-1] The processor 41a reads out backup target data from the cache memory 42a. The processor 41a writes the read-out backup target data in the backup disk 43 via the backup interface unit 43a.

[Step S12-2] The processor 41b reads out backup target data from the cache memory 42b. The processor 41b writes the read-out backup target data in the backup disk 43 via the backup interface unit 43a.

[Step S13] After all the backup target data are saved in the backup disk 43, the supply of the backup power is stopped.

It is assumed that the respective cache memories 42a, 42b include DIMMs of a two-memory configuration and a capacity of one DIMM is 64 GB/DIMM. It is assumed that interface speed of the backup interface unit 43a with respect to the backup disk 43 is 650 MB/s.

In this case, a time for data saving by the backup processing is 394 seconds (=64 GB×2 (two DIMMs)×2 (two parts of the cache memories 42a, 42b)/650 MB/s).

Therefore, for example, during initial construction of the system, when the DIMMs of the two-memory configuration are set in the respective cache memories 42a, 42b, the backup power supply unit 44 having a power supply capacity capable of supplying the backup power for 394 seconds of the data saving time is set.

On the other hand, when the cache memories 42a, 42b are added and DIMMs of a four-memory configuration are formed, a time for the data saving by the backup processing is 788 seconds (=64 GB×4 (four DIMMs)×(two parts of the cache memories 42a, 42b)/650 MB/s).

Therefore, when memory capacities of the cache memories 42a, 42b increase according to an increase in a capacity of a storage and the cache memories 42a, 42b are respectively extended to the DIMMs of the four-memory configuration, the data saving time during the backup processing increases to 788 seconds. Therefore, the backup power supply unit 44 is extended to a power supply capacity capable of supplying the backup power for 788 seconds of the data saving time.

When the memory capacity of the cache memories is extended in this way, the saving time of the cache data increases in proportion to the memory capacity. Therefore, the power supply capacity of the backup power supply unit is also increased. Cost and a device size increase.

In the present disclosure, in view of such a point, even when the memory capacity of the cache memories is extended, reduction of an increase in the power supply capacity of the backup power supply unit is achieved.

<System Configuration>

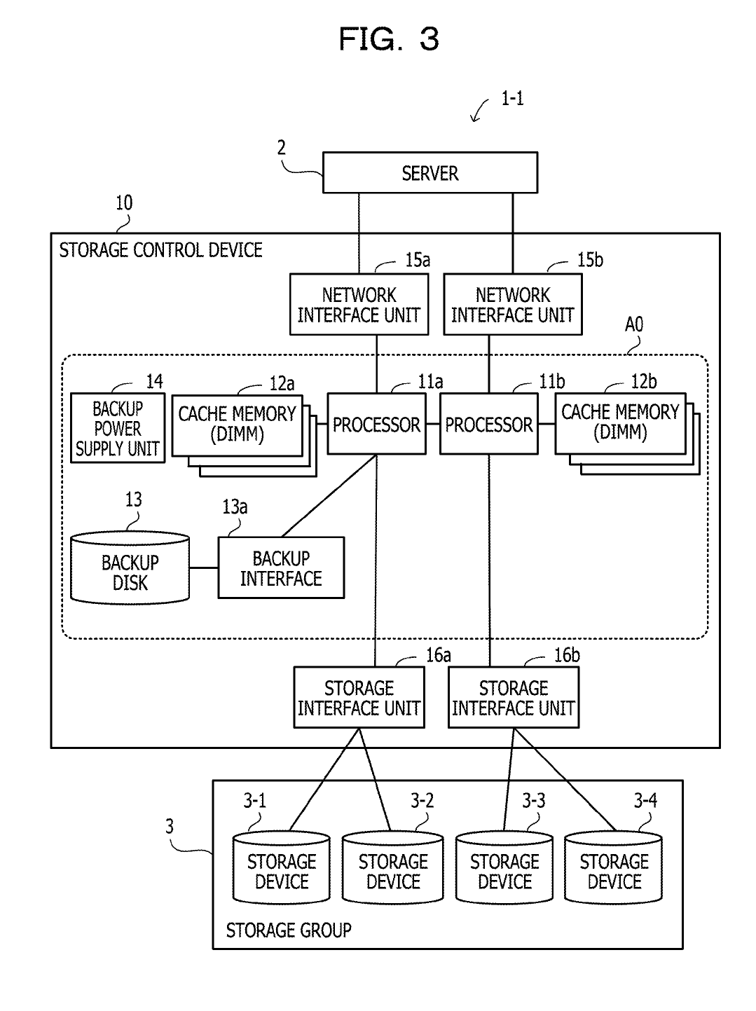

An embodiment of the present disclosure is explained in detail. FIG. 3 is a diagram illustrating an example of the configuration of a storage system. A storage system 1-1 includes a server 2, a storage control device 10, and a storage group 3.

The storage control device 10 includes processors 11a, 11b, cache memories 12a, 12b, a backup disk 13, and a backup interface unit 13a. Further, the storage control device 10 includes a backup power supply unit 14, network interface units 15a, 15b, and storage interface units 16a, 16b. The storage group 3 includes storage devices 3-1, . . . , and 3-4.

A coupling relation among the constituent units is explained. The processor 11a and the processor 11b are coupled to each other. The processor 11a is coupled to the cache memory 12a, the backup interface unit 13a, the network interface unit 15a, and the storage interface unit 16a.

The processor 11b is coupled to the cache memory 12b, the network interface unit 15b, and the storage interface unit 16b.

The backup disk 13 is coupled to the backup interface unit 13a. The storage interface unit 16a is coupled to the storage devices 3-1, 3-2. The storage interface unit 16b is coupled to the storage devices 3-3, 3-4. The server 2 is coupled to the network interface units 15a, 15b.

Processors 11a-1, 11b-1 are, for example, CPUs or micro processing units (MPUs). The processors 11a-1, 11b-1 take a multiprocessor configuration and control the entire function in the storage control device 10.

The cache memories 12a, 12b are used as main memories of the storage control device 10. The cache memories 12a, 12b temporarily stores at least a part of programs to be executed by the processors 11a, 11b and various data used in processing by the programs. For example, DIMMs are used as the cache memories 12a, 12b.

The backup disk 13 is a disk of a nonvolatile memory for backing up data stored in the cache memories 12a, 12b during the supply stop of the normal power supply such as a power failure. For example, a SSD or a HDD is used as the backup disk 13.

The backup interface unit 13a performs transfer interface control of data stored in the cache memories 12a, 12b between the processor 11a and the backup disk 13.

The backup power supply unit 14 supplies the backup power to a backup target section A0 (a dotted line frame in FIG. 3) for a time until data to be stored in the cache memories 12a, 12b is saved in the backup disk 13 during the supply stop of the normal power supply. For example, a nickel hydrogen rechargeable battery is used as the backup power supply unit 14.

The backup target section A0 includes the processors 11a, 11b, the cache memories 12a, 12b, the backup disk 13, and the backup interface unit 13a.

The network interface units 15a, 15b perform interface control with the server 2 and the processors 11a, 11b. The storage interface units 16a, 16b perform interface control with the storage group 3.

The storage devices 3-1, . . . , and 3-4 are, for example, SSDs or HDDs. The storage devices 3-1, . . . , and 3-4 are formed as a disk array by a redundant array of inexpensive disks (RAID) structure. Failure resistance and availability are secured.

<Data Content Stored in the Cache Memories>

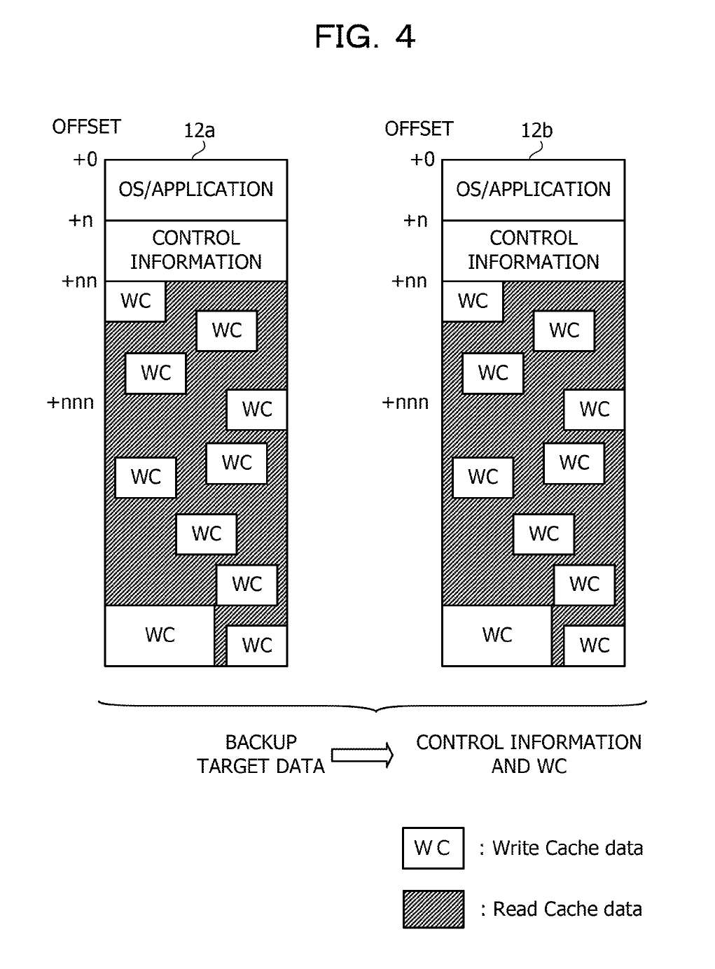

FIG. 4 is a diagram illustrating an example of data content stored in the cache memories. As data stored in the cache memories 12a, 12b, there are, for example, an operating system (OS), applications, control information, write cache data, and read cache data.

The control information includes device configuration information and mapping information of physical resources and logical resources in a virtual environment.

The write cache data is data stored when the cache memories 12a, 12b are used as write caches. That is, the write cache data is data stored in the cache memories 12a, 12b when the cache memories 12a, 12b are used as write caches for temporarily storing data transferred from the storage control device 10 and written in the storage group 3.

The read cache data is data stored when the cache memories 12a, 12b are used as read caches. That is, the read cache data is data stored in the cache memories 12a, 12b when the cache memories 12a and 12b are used as read caches for temporarily storing read data read out from the storage group 3 and transferred to the storage control device 10.

Among the data stored in the cache memories 12a, 12b, backup target data saved in the backup disk 13 during the supply stop of the normal power supply is the control information and the write cache data.

Note that, as illustrated in FIG. 3, the OS, the applications, and the control information are stored in specific regions in the cache memories 12a, 12b. On the other hand, the write cache data and the read cache data are sequentially stored in free spaces in the cache memories 12a, 12b. Therefore, the write cache data and the read cache data are mixed and stored in the cache memories 12a, 12b.

<Hardware Configuration>

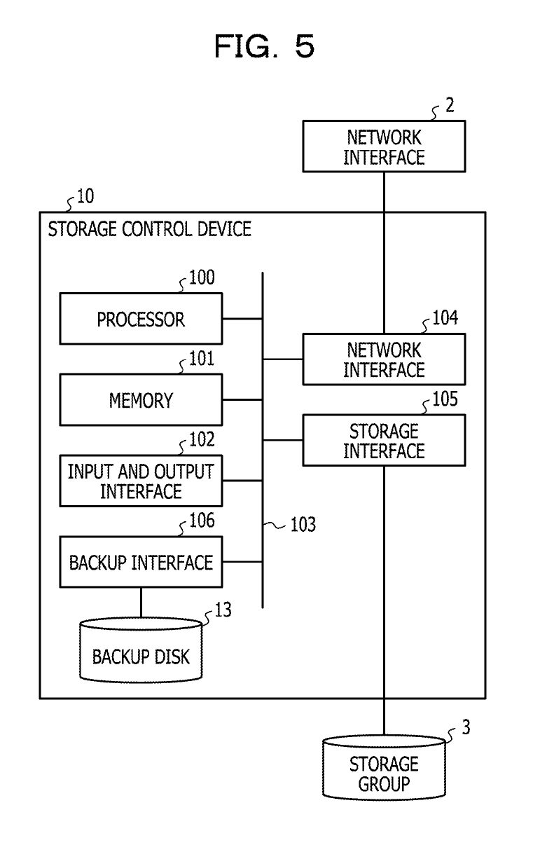

FIG. 5 is a diagram illustrating an example of a hardware configuration of the storage control device. The entire storage control device 10 is controlled by the processor 100. That is, the processor 100 functions as the processors 11a, 11b illustrated in FIG. 3.

A memory 101 and a plurality of peripheral devices are coupled to the processor 100 via a bus 103. The processor 100 is a multiprocessor illustrated in FIG. 3. The processor 100 is, for example, a CPU, an MPU, a digital signal processor (DSP), an application specific integrated circuit (ASIC), or a programmable logic device (PLD). The processor 100 may be a combination of two or more elements among the CPU, the MPU, the DSP, the ASIC, and the PLD.

The memory 101 implements the function of the cache memories 12a, 12b illustrated in FIG. 3. The memory 101 is used as a main storage device of the storage control device 10. In the memory 101, a program of an OS and at least a part of application programs to be executed by the processor 100 are temporarily storage. In the memory 101, various data used in processing by the processor 100 are stored.

Further, the memory 101 is used as an auxiliary storage device of the storage control device 10 as well. A program of an OS, application programs, and various data are stored in the memory 101. The memory 101 may include, as the auxiliary storage device, a semiconductor storage device such as a flash memory or a SSD or a magnetic recording medium such as a HDD.

As the peripheral devices coupled to the bus 103, there are an input and output interface 102, a network interface 104, and a storage interface 105. A monitor (for example, a light emitting diode (LED) or a liquid crystal display (LCD)) functioning as a display device that displays a system state according to a command from the processor 100 is coupled to the input and output interface 102.

Information input devices such as a keyboard and a mouse may be coupled to the input and output interface 102. The input and output interface 102 transmits signals sent from the information input devices to the processor 100.

The input and output interface 102 functions as a communication interface for coupling the peripheral devices. For example, an optical drive device that performs reading of a message recorded in an optical disk using a laser beam or the like may be coupled to the input and output interface 102.

The optical disk is a portable recording medium in which a message is recorded to be readable by reflection of light. As the optical disk, there are a digital versatile disc (DVD), a DVD-random access memory (RAM), a compact disc read only memory (CD-ROM), a CD-recordable (R)/rewritable (RW), and the like.

A memory device and a memory reader writer may be coupled to the input and output interface 102. The memory device is a recording medium implemented with a communication function with the input and output interface 102. The memory reader writer is a device that writes a message in a memory card and reads out a message from the memory card. The memory card is a card-type recording medium.

The network interface 104 is coupled to the server 2 illustrated in FIG. 3 and implements the function of the network interface units 15a, 15b illustrated in FIG. 3. For example, a fibre channel (FC) is used as a protocol of the network interface 104. A signal, data, and the like received by the network interface 104 are output to the processor 100.

The storage interface 105 is coupled to the storage group 3 illustrated in FIG. 3 and implements the function of the storage interface units 16a, 16b illustrated in FIG. 3. For example, a serial attached small computer system interface (SCSI) (SAS) is used as a protocol of the storage interface 105. The storage interface 105 performs data transfer between the processor 100 and the storage group 3.

A backup interface 106 implements the function of the backup interface unit 13a illustrated in FIG. 3. For example, peripheral component interconnect express (PCIe) or serial advanced technology attachment (SATA) is used as an interface protocol of the backup interface 106.

Note that, although not illustrated in FIG. 5, the backup power supply unit 14 is coupled by a backup power supply line to constituent units that perform the backup processing in the storage control device 10. The backup power supply unit 14 supplies the backup power during the supply stop of the normal power supply.

A processing function of the storage control device 10 may be implemented by the hardware configuration explained above. For example, the processor 100 performs the backup processing of the present disclosure by executing a predetermined program, whereby the storage control device 10 may perform the backup processing of the present disclosure.

The storage control device 10 implements the processing function of the present disclosure by executing a program recorded in a computer-readable recording medium. A program describing processing content to be executed by the storage control device 10 may be recorded in various recording media.

For example, a program to be executed by the storage control device 10 may be stored in the auxiliary storage device. The processor 100 loads at least a part of the program in the auxiliary storage device to the main storage device and executes the program. The program may be recorded in a portable recording medium such as an optical disk, a memory device, or a memory card as well. The program stored in the portable recording medium may be executed after being installed in the auxiliary storage device, for example, according to control from the processor 100. The processor 100 may also directly read out the program from the portable recording medium and execute the program.

<Backup Processing>

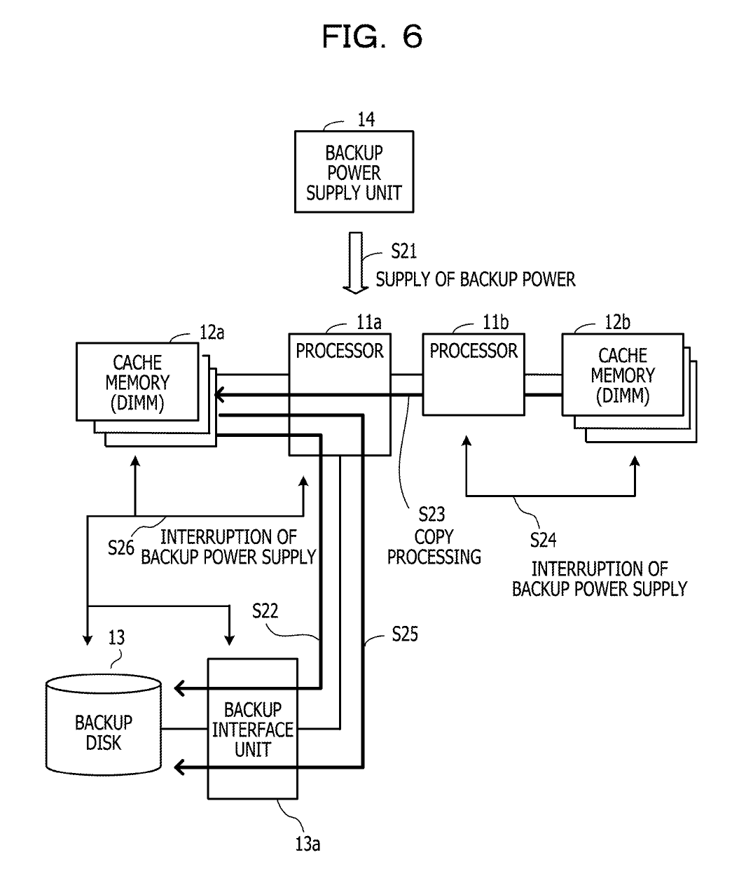

The backup processing in the storage control device 10 is explained. FIG. 6 is a diagram illustrating an example of the backup processing.

[Step S21] The backup power supply unit 14 supplies electric power to the processors 11a, 11b, the cache memories 12a, 12b, the backup interface unit 13a, and the backup disk 13 during the supply stop of the normal power supply.

[Step S22] The processor 11a reads out backup target data from the cache memory 12a. The processor 11a writes the read-out backup target data in the backup disk 13 via the backup interface unit 13a.

[Step S23] The processor 11b reads out backup target data from the cache memory 12b and transmits the backup target data to the processor 11a. The processor 11a receives the backup target data transmitted from the processor 11b and copies the received backup target data to the cache memory 12a.

[Step S24] After completion of the copying, the processor 11b interrupts the backup power supply to the cache memory 12b and the backup power supply to the processor 11b. That is, the backup power supply to the processor 11b and the cache memory 12b is turned off.

[Step S25] The processor 11a reads out the backup target data copied to the cache memory 12a and writes the read-out backup target data in the backup disk 13.

[Step S26] After completion of the writing of all the backup target data in the backup disk 13, the processor 11a interrupts the backup power supply to the cache memory 12a, the backup interface unit 13a, and the backup disk 13. Further, the processor 11a interrupts the backup power supply to the processor 11a.

That is, the backup power supply to the processor 11a, the cache memory 12a, the backup interface unit 13a, and the backup disk 13 is turned off.

<Data Storage Image of the Cache Memories During the Backup Processing>

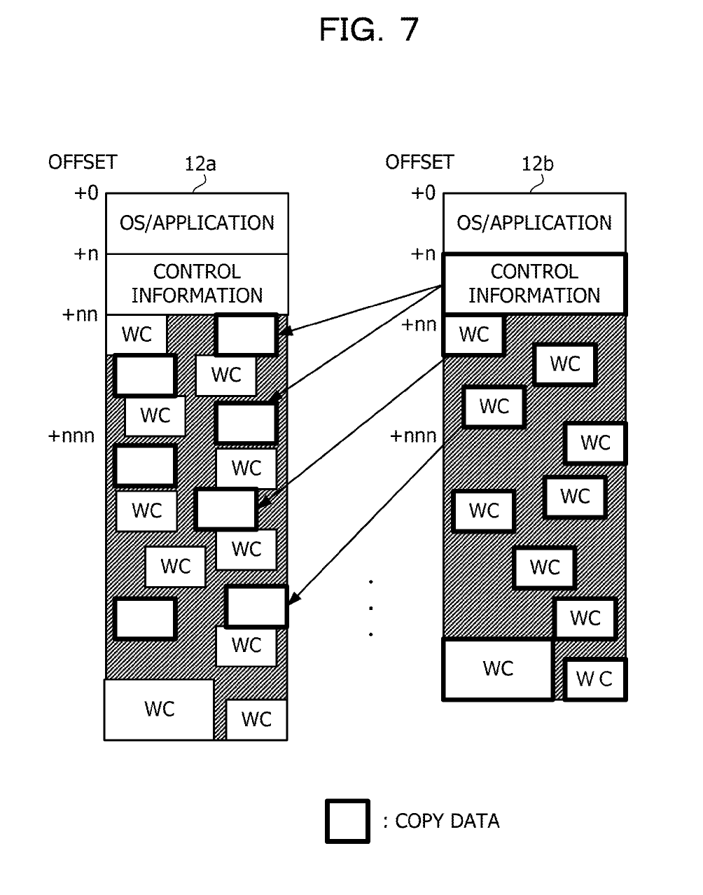

FIG. 7 is a diagram illustrating an example of a data storage image of the cache memories during the backup processing. As explained above with reference to FIG. 4, the control information and the write cache data in the cache memory 12a are the backup target data. The control information and the write cache data in the cache memory 12b are the backup target data.

The control information and the write cache data in the cache memory 12a are transferred to the backup disk 13 and saved in the backup disk 13. The control information and the write cache data in the cache memory 12b are once copied to the cache memory 12a and thereafter transferred to the backup disk 13 and saved in the backup disk 13.

Note that the control information and the write cache data in the cache memory 12b are copied to a non-backup target region in the cache memory 12a. The non-backup target region corresponds to a place where the read cache data not saved in the backup disk 13 is stored in the cache memory 12a.

Because the backup target data of the cache memory 12b is copied to the non-backup target region in the cache memory 12a, destruction of the backup target data may be reduced during copy processing.

<Reduction of an Increase in a Power Supply Capacity of the Backup Power Supply Unit>

Reduction of an increase in a power supply capacity of the backup power supply unit 14 by the backup processing illustrated in FIG. 6 is explained. It is assumed that the cache memories 12a, 12b respectively include DIMMs of a four-memory configuration and the capacity of one DIMM is 64 GB/DIMM.

It is assumed that interface speed of the backup interface unit 13a with respect to the backup disk 13 is 650 MB/s. Further, it is assumed that interface speed between the processor 11a and the processor 11b is 11 GB/s.

In this case, a data saving time by the backup processing in steps S22 and S25 illustrated in FIG. 6 is 788 seconds (=64 GB×4 (four DIMMs)×2 (two parts of the cache memories 12a, 12b)/650 MB/s).

On the other hand, a time for the copy processing in step S23 illustrated in FIG. 6 is 24 seconds (=64 GB×4 (four DIMMs)/11 GB/s).

When compared with the backup processing in the case of FIG. 2, a total time for the backup processing is the same 788 seconds. However, the backup processing time of the cache memory 12b corresponding to the cache memory 42b illustrated in FIG. 2 is reduced from 788 seconds to 24 seconds in FIG. 6.

Therefore, the backup power supply to the cache memory 12b and the backup power supply to the processor 11b may be interrupted after 24 seconds. Power consumption of the backup power supply unit 14 may be reduced by the interruption of the backup power supply.

In this way, during the backup processing, the storage control device 10 copies storage content of the cache memory 12b on the processor 11b side to the cache memory 12a on the processor 11a side and moves data to one side.

After completion of the copying, the storage control device 10 interrupts the backup power supply to the processor 11b and the cache memory 12b and performs data backup on the processor 11a side.

Consequently, because a power supply amount of the backup power supply unit 14 decreases, it is possible to reduce an increase in the power supply capacity of the backup power supply unit 14 even when the memory capacity of the cache memories increases.

<Operation Sequence>

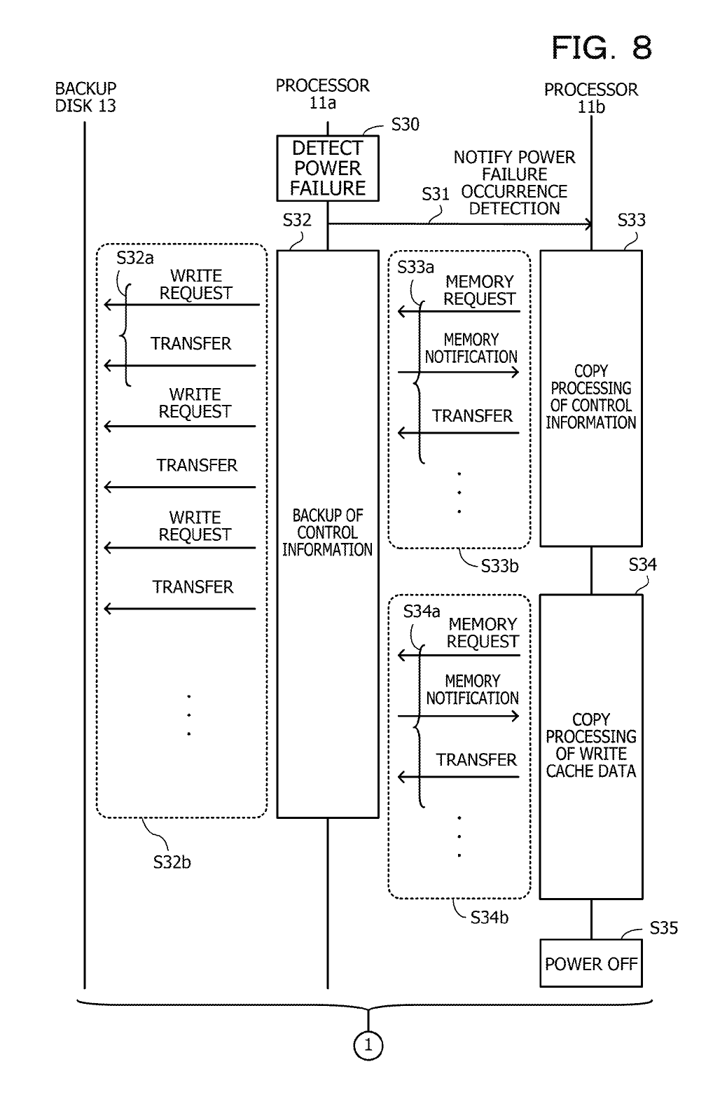

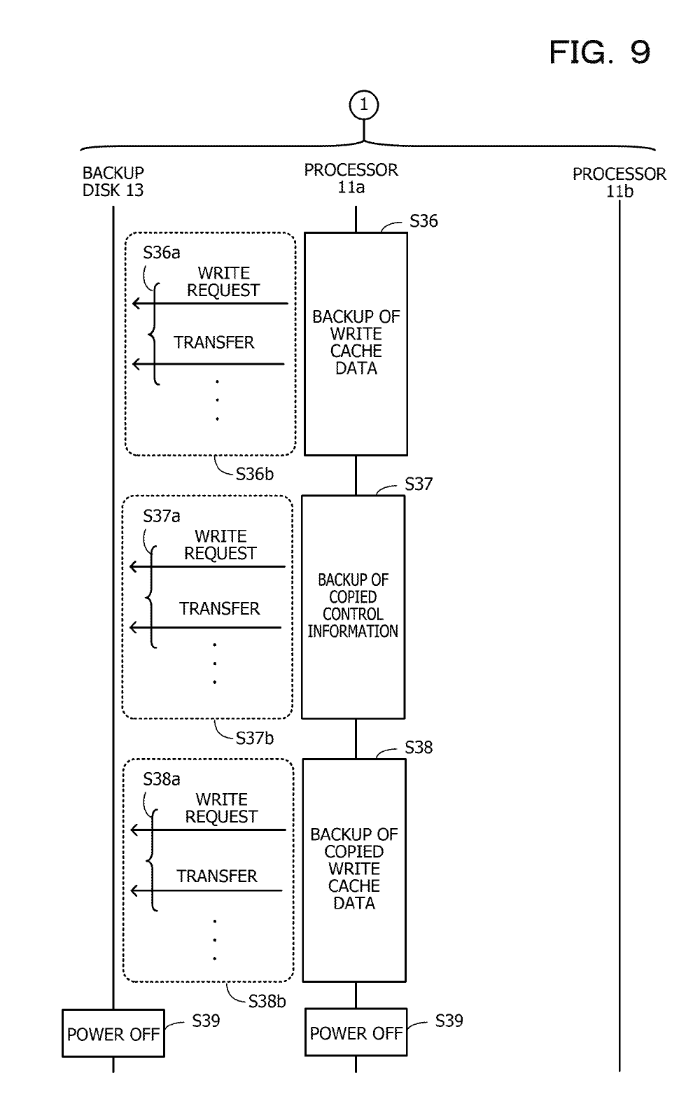

FIGS. 8 and 9 are sequence charts illustrating the operation of the backup processing of the storage control device.

[Step S30] The processor 11a detects a power failure.

[Step S31] The processor 11a transmits a power failure occurrence notification to the processor 11b. The processor 11b detects power failure occurrence.

[Step S32] The backup processing of the control information stored in the cache memory 12a to the backup disk 13 is performed.

[Step S32a] The processor 11a transmits a write request to the backup disk 13 and thereafter transfers the control information to the backup disk 13. Note that the transmission of the write request and the transfer of the control information are performed in a memory management byte unit (for example, 64 KB).

[Step S32b] The processor 11a repeatedly performs the processing in step S32a until the backup processing of the control information is completed.

[Step S33] The copy processing of the control information stored in the cache memory 12b is performed.

[Step S33a] The processor 11b transmits a memory request to the processor 11a and receives a memory notification transmitted from the processor 11a. After the reception of the memory notification, the processor 11b transfers the control information to the processor 11a in the memory management byte unit. The processor 11a transfers (copies) the transferred control information to the cache memory 12a. Note that the transmission of the memory request and the transfer of the control information are performed in the memory management byte unit.

[Step S33b] The processing in step S33a is repeatedly performed between the processors 11a, 11b until the copying of the control information is completed.

[Step S34] The copy processing of the write cache data stored in the cache memory 12b is performed.

[Step S34a] The processor 11b transmits a memory request to the processor 11a and receives a memory notification transmitted from the processor 11a. The processor 11b transfers write cache data to the processor 11a after the reception of the memory notification. The processor 11a transfers (copies) the transferred write cache data to the cache memory 12a. Note that the transmission of the memory request and the transfer of the write cache data are performed in the memory management byte unit.

[Step S34b] The processing in step S34a is repeatedly performed between the processors 11a, 11b until the copying of the write cache data is completed.

[Step S35] The processor 11b turns off the backup power supply to the cache memory 12b and the backup power supply to the processor 11b.

[Step S36] The backup processing of the write cache data stored in the cache memory 12a to the backup disk 13 is performed.

[Step S36a] The processor 11a transmits a write request to the backup disk 13 and thereafter transfers the write cache data to the backup disk 13. Note that the transmission of the write request and the transfer of the write cache data are performed in the memory management byte unit.

[Step S36b] The processor 11a repeatedly performs the processing in step S36a until the backup processing of the write cache data is completed.

[Step S37] The backup processing of the copied control information stored in the cache memory 12a to the backup disk 13 is performed.

[Step S37a] The processor 11a transmits a write request to the backup disk 13 and thereafter transfers the copied control information to the backup disk 13. Note that the transmission of the write request and the transfer of the copied control information are performed in the memory management byte unit.

[Step S37b] The processor 11a repeatedly performs the processing in step S37a until the backup processing of the copied control information is completed.

[Step S38] The backup processing of the copied write cache data stored in the cache memory 12a to the backup disk 13 is performed.

[Step S38a] The processor 11a transmits a write request to the backup disk 13 and thereafter transfers the copied write cache data to the backup disk 13 in the memory management byte unit. Note that the transmission of the write request and the transfer of the write cache data are performed in the memory management byte unit.

[Step S38b] The processor 11a repeatedly performs the processing in step S38a until the backup processing of the copied write cache data is completed.

[Step S39] The processor 11a turns off the backup power supply to the cache memory 12a, the backup power supply to the backup interface unit 13a, the backup power supply to the backup disk 13, and the backup power supply to the processor 11a.

In this way, the processor 11a transfers the backup target data stored in the cache memory 12a to the backup disk 13 in parallel to the copy processing of the backup target data to the non-backup target region of the cache memory 12a. Consequently, a reduction in the backup processing time may be achieved.

<Securing of a Copy Region>

As explained above, during the backup processing, the control information and the write cache data stored in the cache memory 12b are copied to the cache memory 12a. Therefore, when the non-backup target region for copying the control information and the write cache data is insufficient in the cache memory 12a, control for securing the region is performed during the normal operation (during a non-power failure).

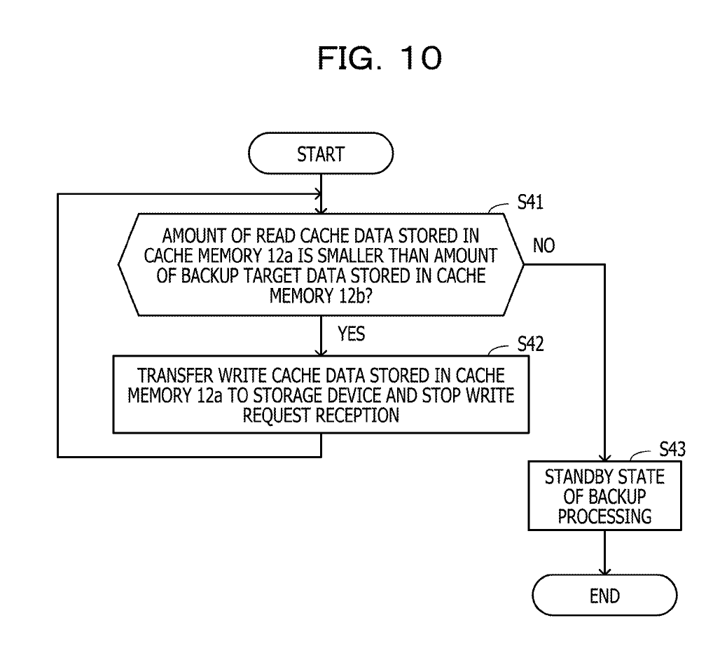

FIG. 10 is a flowchart illustrating an example of operation for securing a copy region.

[Step S41] The processor 11a determines whether an amount of read cache data stored in the cache memory 12a is smaller than an amount of backup target data, which is preferably copied, stored in the cache memory 12b.

When the amount of the read cache data stored in the cache memory 12a is smaller than the amount of the backup target data stored in the cache memory 12b (when the copy region is insufficient), the processing proceeds to step S42.

When the amount of the read cache data stored in the cache memory 12a is larger than the amount of the copy target data stored in the cache memory 12b (the copy region is sufficient), the processing proceeds to step S43.

[Step S42] The processor 11a performs processing for stopping reception of a write request from the server 2 while transferring the write cache data stored in the cache memory 12a to the storage devices 3-1, . . . , and 3-4. This processing is executed until the amount of the read cache data stored in the cache memory 12a exceeds the amount of the backup target data stored in the cache memory 12b.

[Step S43] Because a region for copying the backup target data of the cache memory 12b to the cache memory 12a is secured, the processor 11a comes into a standby state concerning the backup processing during the normal power supply stop.

In this way, the processor 11a compares a data amount (represented as D1) that may be written in the non-backup target region of the cache memory 12a and a data amount (represented as D2) of the backup target data of the cache memory 12b.

When D1 is smaller than D2, the processor 11a prohibits data writing in the cache memory 12a while transferring the backup target data of the cache memory 12a to the storage devices 3-1, . . . , and 3-4 until D1 becomes equal to or larger than D2.

Consequently, even when the non-backup target region of the cache memory 12a is insufficient, it is possible to increase the non-backup target region and secure the copy region.

<Possibility Determination for the Backup Processing Corresponding to a Power Supply Capacity of the Backup Power Supply Unit>

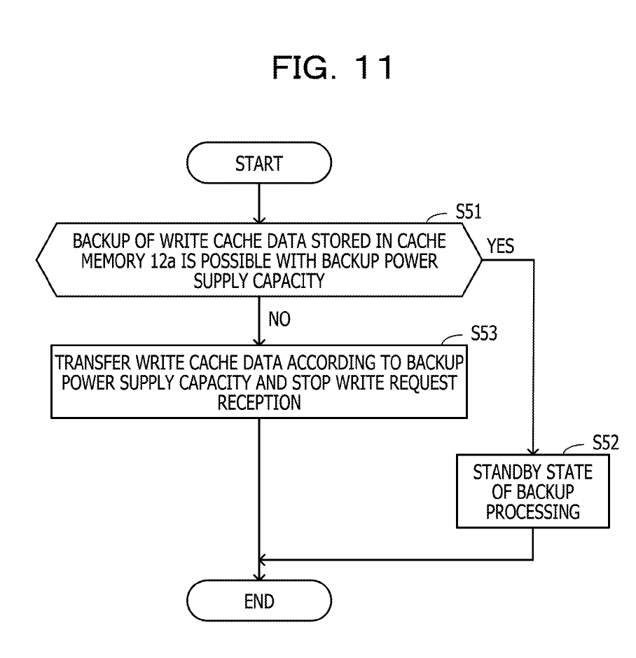

FIG. 11 is a flowchart illustrating an example of a possibility determination operation for the backup processing corresponding to a power supply capacity of the backup power supply unit. Note that the possibility determination operation for the backup processing illustrated in FIG. 11 is performed during the normal operation (during the non-power failure time).

[Step S51] The processor 11a determines whether the backup processing of the amount of the write cache data stored in the cache memory 12a and the amount of the write cache data copied to the cache memory 12a is possible with the power supply capacity of the backup power supply unit 14.

When the backup processing is possible (the backup power supply capacity is sufficient), the processing proceeds to step S52. When the backup processing is impossible (the backup power supply capacity is insufficient), the processing proceeds to step S53.

[Step S52] Because the backup processing is determined as possible, the processor 11a comes into a standby state concerning the backup processing during the normal power supply stop.

[Step S53] The processor 11a stops the reception of the write request from the server 2 and transfers the write cache data (including the write cache data copied from the cache memory 12b) stored in the cache memory 12a to the storage devices 3-1, . . . , and 3-4 according to the power supply capacity of the backup power supply unit 14.

In this way, when the power supply capacity of the backup power supply unit 14 is insufficient, the processor 11a performs the possibility determination for the backup processing of the write cache data corresponding to the power supply capacity of the backup power supply unit 14. Consequently, a backup processing amount (a write cache data amount) may be limited.

<Extension of the System by Scale-Out>

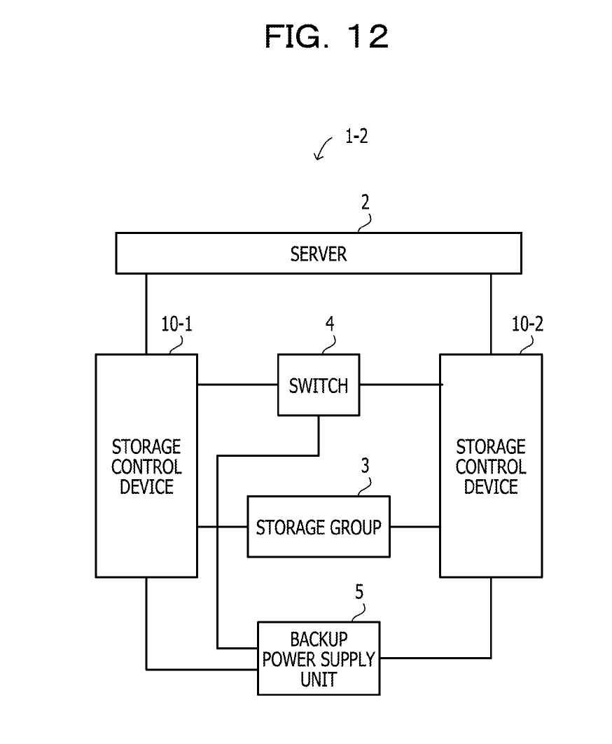

A configuration and operation during system extension by scale-out are explained with reference to FIGS. 12 to 14. FIG. 12 is a diagram illustrating an example of the configuration of a storage system. A storage system 1-2 after the system extension includes the server 2, storage control devices 10-1, 10-2, the storage group 3, a switch 4, and a backup power supply unit 5.

The storage control devices 10-1, 10-2 are coupled by the switch 4 to have a scale-out coupling configuration capable of extending the storage control device.

By adopting the storage control device in a multiple configuration, it is possible to perform duplication of data and load distribution of input and output (IC)) processing, which is processing for writing and reading out data in and from the storage group 3. Note that the backup power supply unit 5 supplies the backup power to the two storage control devices 10-1, 10-2 and the switch 4.

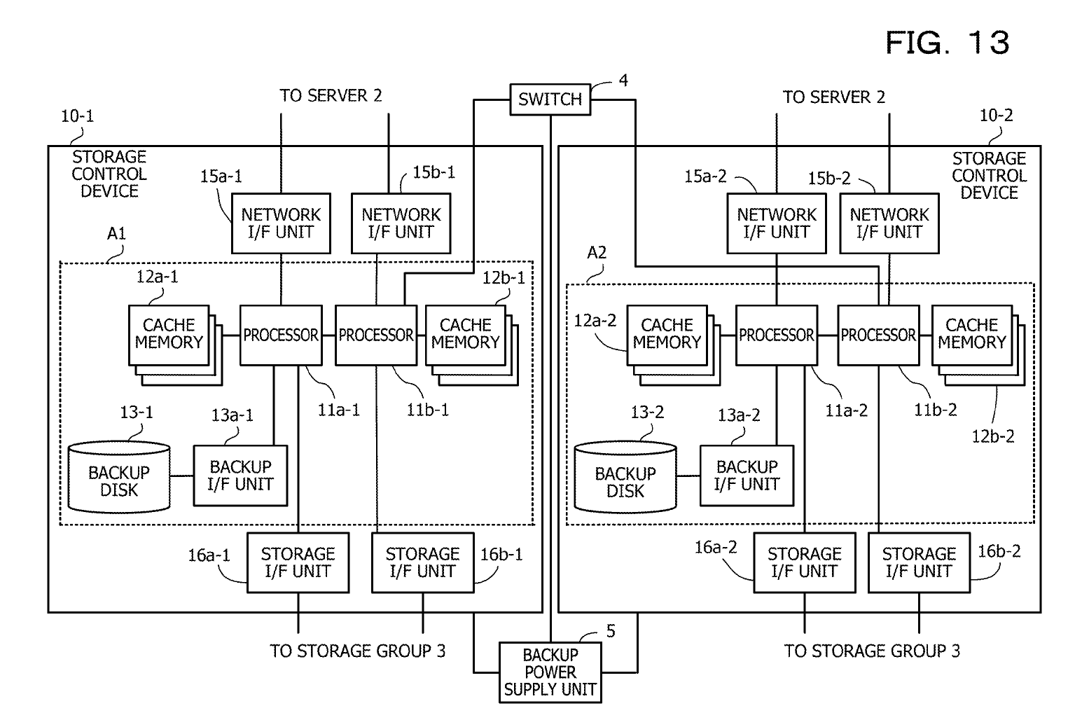

FIG. 13 is a diagram illustrating an example of the configuration of the storage control device. In the following explanation, an interface is sometimes described as I/F. The storage control device 10-1 includes processors 11a-1, 11b-1, cache memories 12a-1, 12b-1, a backup disk 13-1, a backup I/F unit 13a-1, network I/F units 15a-1, 15b-1, and storage I/F units 16a-1, 16b-1.

The storage control device 10-2 includes processors 11a-2, 11b-2, cache memories 12a-2, 12b-2, a backup disk 13-2, a backup I/F unit 13a-2, network I/F units 15a-2, 15b-2, and storage I/F units 16a-2, 16b-2. Note that the backup disk 13-2 and the backup I/F unit 13a-2 in the storage control device 10-2 may be deleted as constituent units.

On the other hand, a backup power supply from the backup power supply unit 5 is supplied to backup target sections A1 and A2 (in a dotted line frame in FIG. 13).

The backup target section A1 includes the processors 11a-1, 11b-1, the cache memories 12a-1, 12b-1, the backup disk 13-1, and the backup I/F unit 13a-1.

The backup target section A2 includes the processors 11a-2, 11b-2, the cache memories 12a-2, 12b-2, the backup disk 13-2, and the backup I/F unit 13a-2.

A coupling relation among the constituent units is explained. In the storage control device 10-1, the processor 11a-1 and the processor 11b-1 are coupled to each other. The processor 11a-1 is coupled to the cache memory 12a-1, the backup I/F unit 13a-1, the network I/F unit 15a-1, and the storage I/F unit 16a-1.

The processor 11b-1 is coupled to the cache memory 12b-1, the network I/F unit 15b-1, and the storage I/F unit 16b-1. The backup disk 13-1 is coupled to the backup I/F unit 13a-1.

In the storage control device 10-2, the processor 11a-2 is coupled to the cache memory 12a-2, the backup I/F unit 13a-2, the network I/F unit 15a-2, and the storage I/F unit 16a-2.

The processor 11b-2 is coupled to the cache memory 12b-2, the network I/F unit 15b-2, and the storage I/F unit 16b-2. The backup disk 13-2 is coupled to the backup I/F unit 13a-2.

Note that the storage group 3 is coupled to the storage I/F units 16a-1, 16b-1 and the storage I/F units 16a-2, 16b-2. The server 2 is coupled to the network I/F units 15a-1, 15b-1 and the network I/F units 15a-2, 15b-2. The switch 4 is coupled to the processors 11b-1, 11b-2.

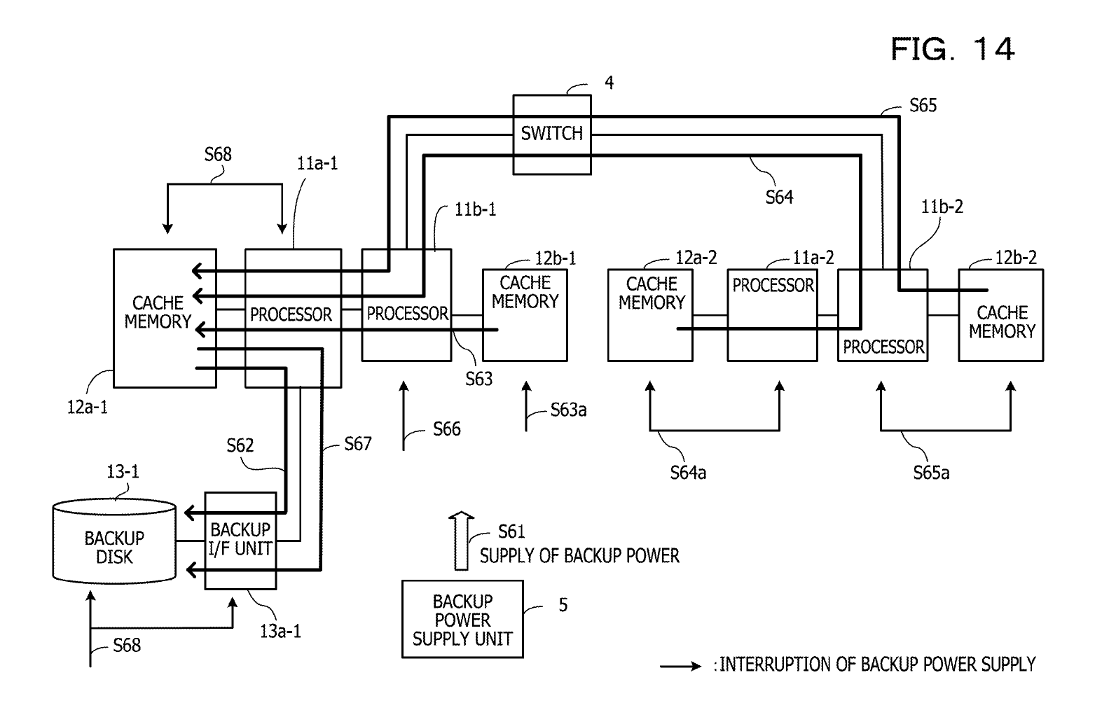

FIG. 14 is a diagram illustrating an example of the backup processing.

[Step S61] The backup power supply unit 5 supplies the backup power to the constituent units included in the backup target section A1 of the storage control device 10-1, the constituent units included in the backup target section A2 of the storage control device 10-2, and the switch 4 during the supply stop of the normal power supply.

[Step S62] The processor 11a-1 reads out backup target data from the cache memory 12a-1. The processor 11a-1 writes the read-out backup target data in the backup disk 13-1 via the backup I/F unit 13a-1.

[Step S63] The processor 11b-1 reads out backup target data from the cache memory 12b-1 and transmits the backup target data to the processor 11a-1. The processor 11a-1 receives the backup target data transmitted from the processor 11b-1 and copies the received backup target data to the cache memory 12a-1.

[Step S63a] After completion of the copying of the backup target data in the cache memory 12b-1, the processor 11b-1 interrupts the backup power supply to the cache memory 12b-1.

[Step S64] The processor 11a-2 reads out backup target data from the cache memory 12a-2 and transmits the backup target data to the processor 11b-2. The processor 11b-2 transmits the received backup target data to the processor 11b-1 via the switch 4.

The processor 11b-1 transmits the received backup target data to the processor 11a-1. The processor 11a-1 receives the backup target data transmitted from the processor 11b-1. The processor 11a-1 copies the received backup target data to the cache memory 12a-1.

[Step S64a] After completion of the copying of the backup target data in the cache memory 12a-2, the processor 11a-2 interrupts the backup power supply to the cache memory 12a-2 and the backup power supply to the processor 11a-2.

[Step S65] The processor 11b-2 reads out backup target data from the cache memory 12b-2 and transmits the read-out backup target data to the processor 11b-1 via the switch 4.

The processor 11b-1 transmits the received backup target data to the processor 11a-1. The processor 11a-1 receives the backup target data transmitted from the processor 11b-1. The processor 11a-1 copies the received backup target data to the cache memory 12a-1.

[Step S65a] After completion of the copying of the backup target data in the cache memory 12b-2, the processor 11b-2 interrupts the backup power supply to the cache memory 12b-2 and the backup power supply to the processor 11b-2.

[Step S66] After completion of the copying of the backup target data in the cache memories 12b-1, 12a-2, 12b-2, the processor 11b-1 interrupts the backup power supply to the processor 11b-1.

[Step S67] The processor 11a-1 reads out the backup target data copied to the cache memory 12a-1 and writes the read-out backup target data in the backup disk 13-1 via the backup I/F unit 13a-1.

[Step S68] After completion of the writing of all the backup target data in the backup disk 13-1, the processor 11a-1 interrupts the backup power supply to the cache memory 12a-1, the backup I/F unit 13a-1, and the backup disk 13-1. Further, the processor 11a-1 interrupts the backup power supply to the processor 11a-1.

In the storage system 1-2, it is assumed that the cache memories 12a-1, 12b-1, 12a-2, 12b-2 respectively include DIMMs of the four-memory configuration and the capacity of one DIMM is 64 GB/DIMM. It is assumed that interface speed between the processor 11b-1 and the processor 11b-2 via the switch 4 is 7 GB/s.

In this case, a time for the copy processing of the backup target data of the cache memories 12a-2, 12b-2 is 74 seconds (=64 GB×4×2/7 GB/s).

The total time for the backup processing is 788 seconds as explained above. However, the backup processing time for the cache memories 12a-2, 12b-2 is reduced from 788 seconds to 74 seconds.

Therefore, the backup power supply to the processors 11a-1, 11b-2 on the storage control device 10-2 side and the backup power supply to the cache memories 12a-2, 12b-2 may be interrupted after 74 seconds at the latest. Therefore, because the backup power supply is interrupted after 74 seconds, power consumption of the backup power supply unit 5 may be reduced. It is possible to reduce an increase in the power supply capacity of the backup power supply unit 5.

<Backup Processing in the Case of N Processors>

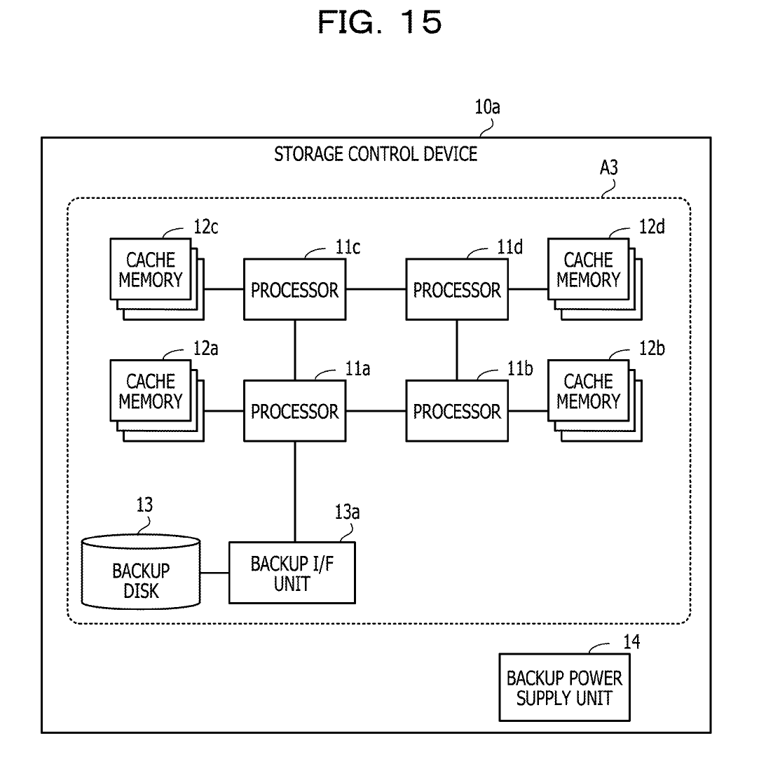

As backup processing of a multiprocessor configuration including N (N is an integer equal to or larger than 3) processors, backup processing performed when N=4 is explained. FIG. 15 is a diagram illustrating an example of the configuration of a storage control device including four processors. Note that illustration of a network I/F unit and a storage I/F unit is omitted.

A storage control device 10a includes the processors 11a, 11b, 11c, 11d, cache memories 12a, 12b, 12c, 12d, the backup disk 13, the backup I/F unit 13a, and the backup power supply unit 14.

As a coupling relation among the constituent units, the processors 11a, 11b, 11c, 11d are coupled in a ring shape. The cache memory 12a is coupled to the processor 11a, the cache memory 12b is coupled to the processor 11b, the cache memory 12c is coupled to the processor 11c, and the cache memory 12d is coupled to the processor 11d.

The backup I/F unit 13a is coupled to the processor 11a. The backup disk 13 is coupled to the backup I/F unit 13a. The backup power supply unit 14 supplies the backup power to the constituent units in a backup target section A3.

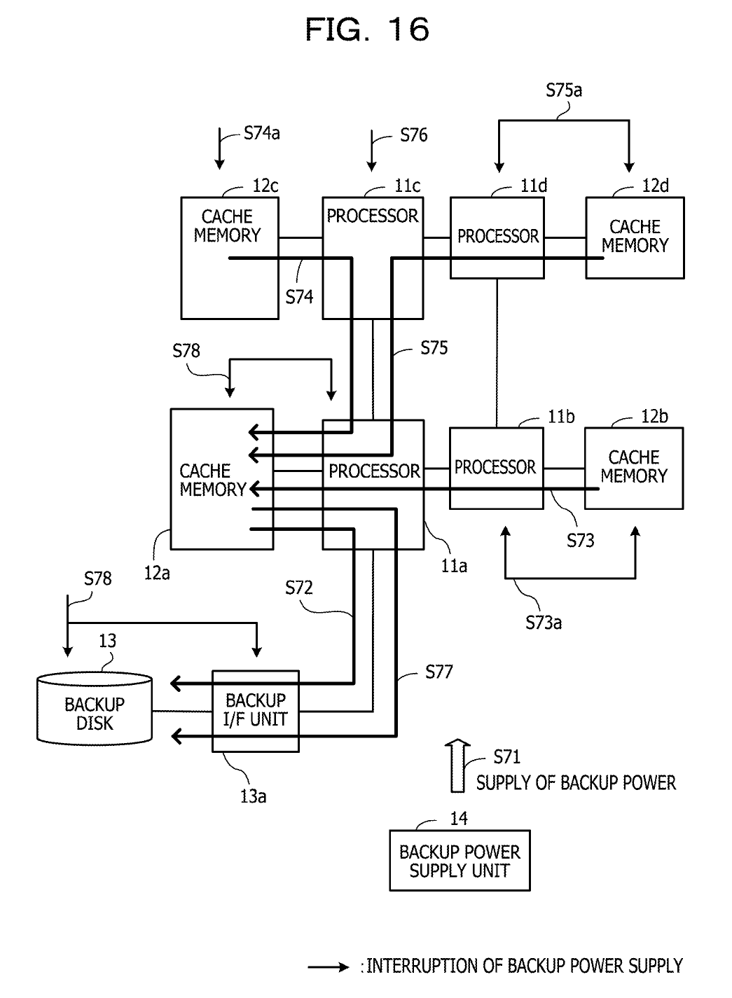

FIG. 16 is a diagram illustrating an example of the backup processing.

[Step S71] The backup power supply unit 14 supplies the backup power to the constituent units included in the backup target section A3 of the storage control device 10a during the supply stop of the normal power supply.

[Step S72] The processor 11a reads out backup target data from the cache memory 12a. The processor 11a writes the read-out backup target data in the backup disk 13 via the backup I/F unit 13a.

[Step S73] The processor 11b reads out backup target data from the cache memory 12b and transmits the backup target data to the processor 11a. The processor 11a receives the backup target data transmitted from the processor 11b and copies the received backup target data to the cache memory 12a.

[Step S73a] After completion of the copying of the backup target data in the cache memory 12b, the processor 11b interrupts the backup power supply to the cache memory 12b and the backup power supply to the processor 11b.

[Step S74] The processor 11c reads out backup target data from the cache memory 12c and transmits the backup target data to the processor 11a. The processor 11a receives the backup target data transmitted from the processor 11c and copies the received backup target data to the cache memory 12a.

[Step S74a] After completion of the copying of the backup target data in the cache memory 12c, the processor 11c interrupts the backup power supply to the cache memory 12c.

[Step S75] The processor 11d reads out backup target data from the cache memory 12d and transmits the read-out backup target data to the processor 11c.

The processor 11c transmits the received backup target data to the processor 11a. The processor 11a receives the backup target data transmitted from the processor 11c. The processor 11a copies the received backup target data to the cache memory 12a.

[Step S75a] After completion of the copying of the backup target data in the cache memory 12d, the processor 11d interrupts the backup power supply to the cache memory 12d and the backup power supply to the processor 11d.

[Step S76] After completion of the copying of the backup target data in the cache memories 12c, 12d, the processor 11c interrupts the backup power supply to the processor 11c.

[Step S77] The processor 11a reads out the backup target data copied to the cache memory 12a and writes the read-out backup target data in the backup disk 13 via the backup I/F unit 13a.

[Step S78] After completion of the writing of all the backup target data in the backup disk 13, the processor 11a interrupts the backup power supply to the cache memory 12a, the backup I/F unit 13a, and the backup disk 13. Further, the processor 11a interrupts the backup power supply to the processor 11a.

The processing functions of the control device 1 and the storage control devices 10, 10-1, 10-2, 10a of the present disclosure explained above may be implemented by a computer. In this case, a program describing processing content of the functions that the control device 1 and the storage control devices 10, 10-1, 10-2, 10a preferably have is provided. The program is executed by the computer, whereby the processing functions are implemented on the computer.

The program describing the processing content may be recorded in a computer-readable recording medium. As the computer-readable recording medium, there are a magnetic storage device, an optical disk, a semiconductor memory, and the like. As the magnetic storage device, there are a hard disk device (HDD), a flexible disk (FD), a magnetic tape, and the like. As the optical disk, there are a CD-ROM\RW and the like.

When the program is distributed, for example, a portable recording medium such as a CD-ROM in which the program is recorded is sold. The program also be stored in a storage device of a server computer and transferred from the server computer to other computers via a network.

The computer, which executes the program, stores, for example, the program recorded in the portable recording medium or the program transferred from the server computer in a storage device of the computer. The computer reads the program from the storage device of the computer and executes processing conforming to the program. The computer may also directly read the program from the portable recording medium and execute processing conforming to the program.

Every time a program is transferred from the server computer coupled via the network, the computer may sequentially execute processing conforming to the received program. At least a part of the processing functions may also be implemented by an electronic circuit such as a DSP, an ASIC, or a PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A control device comprising:
a nonvolatile memory;
a first processor;
a first volatile memory coupled to the first processor;
a second processor; and
a second volatile memory coupled to the second processor, wherein
the first processor is configured to transmit first data stored in the first volatile memory to the second processor by using electric power supplied from a backup power supply,
the second processor is configured to store the first data in the second volatile memory,
after storing the first data in the second volatile memory, the backup power supply stops supplying the electric power to at least one of the first volatile memory and the first processor, and
the second processor is configured to store, in the nonvolatile memory, the first data stored in the second volatile memory.

2. The control device according to claim 1, wherein
after storing the first data in the nonvolatile memory, the second processor is configured to cause the backup power supply to stop supplying the electric power to at least one of the second volatile memory, the second processor, and the nonvolatile memory.

3. The control device according to claim 1, wherein
when a free space of the second volatile memory is less than a data amount of the first data, the second processor is configured to
prohibit writing in the second volatile memory,
transmit second data stored in the second volatile memory to a data storage device, and
when the free space of the second volatile memory becomes equal to or greater than the data amount of the first data due to transmission of the second data to the data storage device, cancels a prohibition of the writing in the second volatile memory.

4. The control device according to claim 3, wherein
the second processor is configured to store the second data in the nonvolatile memory.

5. The control device according to claim 4, wherein
the second volatile memory includes a read cache memory and a write cache memory, and
the second processor is configured to
store the first data in the read cache memory, and
store the second data in the write cache memory.

6. The control device according to claim 5, wherein
the second processor is configured to store the second data in the nonvolatile memory in parallel with storing of the first data in the read cache memory.

7. A method using a control device including a nonvolatile memory, a first processor, a first volatile memory coupled to the first processor, a second processor and a second volatile memory coupled to the second processor, the method comprising:
transmitting, from the first processor to the second processor, first data stored in the first volatile memory by using electric power supplied from a backup power supply;
storing, by the second processor, the first data in the second volatile memory;
after the storing of the first data in the second volatile memory, causing the backup power supply to stop supplying the electric power to at least one of the first volatile memory and the first processor; and
storing, by the second processor, in the nonvolatile memory, the first data stored in the second volatile memory.

8. The method according to claim 7, further comprising:
after the storing of the first data in the nonvolatile memory, causing the backup power supply to stop supplying the electric power to at least one of the second volatile memory, the second processor, and the nonvolatile memory.

9. The method according to claim 7, further comprising:
when a free space of the second volatile memory is less than a data amount of the first data, prohibiting, by the second processor, writing in the second volatile memory;
transmitting, by the second processor, second data stored in the second volatile memory to a data storage device; and
when the free space of the second volatile memory becomes equal to or greater than the data amount of the first data due to transmission of the second data to the data storage device, cancelling, by the second processor, a prohibition of the writing in the second volatile memory.

10. The method according to claim 9, further comprising:
storing, by the second processor, the second data in the nonvolatile memory.

11. The method according to claim 10, wherein the second volatile memory includes a read cache memory and a write cache memory, and the method further comprises:
storing the first data in the read cache memory; and
storing the second data in the write cache memory.

12. The method according to claim 11, further comprising:
storing, by the second processor, the second data in the nonvolatile memory in parallel with storing of the first data in the read cache memory.

13. A non-transitory computer-readable storage medium storing a program that causes a control device to execute a process, the control device including a nonvolatile memory, a first processor, a first volatile memory coupled to the first processor, a second processor and a second volatile memory coupled to the second processor, the process comprising:
transmitting, from the first processor to the second processor, first data stored in the first volatile memory by using electric power supplied from a backup power supply;
storing, by the second processor, the first data in the second volatile memory;
after the storing of the first data in the second volatile memory, causing the backup power supply to stop supplying the electric power to at least one of the first volatile memory and the first processor; and
storing, by the second processor, in the nonvolatile memory, the first data stored in the second volatile memory.

14. The non-transitory computer-readable storage medium according to claim 13, the process further comprising:
after the storing of the first data in the nonvolatile memory, causing the backup power supply to stop supplying the electric power to at least one of the second volatile memory, the second processor, and the nonvolatile memory.

15. The non-transitory computer-readable storage medium according to claim 14, the process further comprising:
when a free space of the second volatile memory is less than a data amount of the first data, prohibiting, by the second processor, writing in the second volatile memory;
transmitting, by the second processor, second data stored in the second volatile memory to a data storage device; and
when the free space of the second volatile memory becomes equal to or greater than the data amount of the first data due to transmission of the second data to the data storage device, cancelling, by the second processor, a prohibition of the writing in the second volatile memory.

16. The non-transitory computer-readable storage medium according to claim 15, the process further comprising:
storing, by the second processor, the second data in the nonvolatile memory.

17. The non-transitory computer-readable storage medium according to claim 16, wherein the second volatile memory includes a read cache memory and a write cache memory, and the process further comprises:
storing the first data in the read cache memory; and
storing the second data in the write cache memory.

18. The non-transitory computer-readable storage medium according to claim 17, the process further comprising:
storing, by the second processor, the second data in the nonvolatile memory in parallel with storing of the first data in the read cache memory.
